(19) United States
(12) Patent Application Publication
(10) Pub. No.: US 2012/0216641 A1
(43) Pub. Date: Aug. 30, 2012

(54) ARRANGEMENT AND METHOD FOR DAMPING OF A PISTON MOVEMENT

(76) Inventor: Ortwin Schlüter, Jarna (SE)

(21) Appl. No.: 13/504,673

(22) PCT Filed: Oct. 20, 2010
(86) PCT No.: PCT/SE2010/051133

§ 371 Date: Apr. 27, 2012

(30) Foreign Application Priority Data
Nov. 2, 2009 (SE) 0950814-4

(51) Int. Cl. F15B 13/04; F16H 3/08

(52) U.S. Cl. 74/335; 91/403; 91/471

(57) ABSTRACT

Arrangement for damping of a piston movement in a compressed air cylinder (10; 20), which arrangement includes a compressed air cylinder (10; 20), a valve device, a compressed air device, and a control unit. The control unit controls valve devices such that the movement of the piston is damped before the piston reaches the casing of the compressed air cylinder. A method for control of the arrangement is disclosed.

### TECHNICAL FIELD

The invention relates to an arrangement for damping of a piston movement in a compressed air cylinder according to the preamble of claim 1.

The invention refers also to a gearbox comprising the arrangement, and to a method for damping of a piston movement.

### BACKGROUND

Various types of gearboxes are used in, for example, vehicles to adjust the power transmission from the vehicle's engine to the drives shaft which drive the vehicle's powered wheels. The gearbox comprises a main shaft and, parallel thereto, a countershaft, both of which have a number of gearwheels arranged round them. The number of gearwheels along the shafts depends on the number of gear positions in the gearbox.

Gear changing involves selected gearwheels being connected/disconnected to/from the drive shaft or the countershaft so that desired torque is transmitted to the drive shaft. It also involves the movements of the gear lever being transmitted to a lateral thrust shaft which is movable in a transverse direction relative to the main shaft and the countershaft, and being transmitted to a longitudinal shaft which is moved parallel with the main shaft and the countershaft. The various shafts effect engagement/disengagement of the gearwheels along the countershaft and the main shaft.

Connecting/disconnecting the gearwheels quickly and correctly to/from the respective shafts round which they are arranged entails the application of a considerable axially directed force to the shafts. A particularly large amount of force is required at low temperatures at which the viscosity of the lubricant changes, causing the various parts in the gearbox to slide less easily relative to one another. One way of alleviating this is to provide a compressed air cylinder associated with the respective shaft to assist the shaft movement, in which case the compressed air cylinder is situated in an extension of the respective shaft so that when compressed air from the vehicle's compressed air system is supplied the compressed air cylinder assists the shaft movement.

The compressed air cylinder has a longitudinal spindle and a piston which is situated in a circular cylindrical cavity and in which the spindle is fastened. The piston and the spindle are movable between at least two different positions in the cavity. The piston's placing in the cavity results in a space V1 on one side of the piston and a space V2 on the opposite side of the piston. The piston and hence the lateral thrust shaft connected to it can be moved in desired directions by connecting the compressed air and pressurising the respective spaces V1 and V2.

When compressed air is supplied to the space V1 or V2, the piston moves quickly towards one of the extreme positions, at which it stops when it hits the surrounding casing of the cylinder. This impact gives rise to a loud clattering noise when the piston hits the casing.

There are various different solutions for damping this clattering noise. One variant is to provide an impact-damping elastic element between the contact surfaces of the piston and of the casing. The disadvantage of that solution is that after a time the impact-damping element disintegrates, leading to loss of damping and, in the worse case, to the remaining fragments retarding or locking the piston in the casing.

Another solution for damping this clattering noise is to place a permanent constriction on the compressed air supply to the respective spaces in order to reduce the speed of the piston so that it does not move so quickly towards the casing. However, the constriction also slows down the actual gear change, a clear disadvantage in that rapid gear changing is important for the gearbox.

A further damping device is hydraulic damping, but this is expensive in that it is complicated, requires maintenance and does not work satisfactorily at low temperatures.

There is therefore need for an effective arrangement, which does not suffer from the disadvantages described above, for damping of the piston so that it does not hit the casing.

### SUMMARY OF THE INVENTION

The object of the present invention is to eliminate the above problem. It is achieved by an arrangement according to the first independent claim, and by a method according to the second independent claim.

The arrangement for damping of a piston movement in a compressed air cylinder comprises:
a compressed air cylinder with at least one longitudinal spindle intended to transmit force from the compressed air cylinder, said compressed air cylinder comprising a casing within which a piston joined to the longitudinal spindle is so placed that a space is formed on each side of the piston and that each space has a compressed air hose or pipe connected to it;
a valve device arranged along each compressed air hose or pipe;
a compressed air device for supply of compressed air to each space via the respective compressed air hose or pipe, and
a control unit connected to each valve device in order to control when compressed air is supplied to, and when it is allowed to leave, the spaces in the compressed air cylinder via the compressed air hoses or pipes.

The arrangement according to the invention is characterised in that the control unit comprises means for controlling the valve devices in such a way that by controlling the supply of compressed air to either of the spaces in the compressed air cylinder it generates a movement of the piston and the spindle thereto connected, and also controls the valve devices so that compressed air is supplied to the other space before the movement of the piston has begun, in order thereby to damp the movement of the piston.

The damping medium used by the arrangement is thus compressed air which is already available in the arrangement for generating the desired piston movement. This arrangement therefore involves extremely few components in that the damping medium, the compressed air, is supplied to and removed from the compressed air cylinder via the two compressed air hoses which are also used for generating the desired piston movement of the compressed air cylinder.

The arrangement results in very good damping of the piston before it meets the casing of the compressed air cylinder, without being complicated and hence expensive. The good damping is achieved by the compressed air used for damping the movement of the piston being supplied already before the movement of the piston begins.

An embodiment of the arrangement comprises means for detecting the position of the piston. A detected position is passed on as a parameter to the control unit and is used therein to determine when compressed air has to be supplied to the spaces for optimum damping. This determination of the piston's position makes it possible for the damping to be varied and adjusted in response to surrounding factors such as the compressed air cylinder's temperature, which considerably affects the piston's speed of movement.

In an embodiment of the arrangement, the means for detecting the position of the piston is situated in an axial extension of the spaces and comprises a second spindle coaxial with the first spindle but situated on the opposite side of the piston from the first spindle, and a position determination unit comprising a recess in which the second spindle moves so that the piston's position in the compressed air cylinder can be detected. This type of means for detecting the position of the piston provides a reliable and precise determination of its position from which its movement can also be determined.

In an embodiment of the arrangement, the piston is movable between two positions in the compressed air cylinder, and in another embodiment of the arrangement the piston is movable between three positions in the compressed air cylinder, the middle position being a position of rest to which the piston is returned by a coil spring placed round the spindle between the piston and the casing on each side of the piston. The configuration of the compressed air cylinder may vary depending on the application in which it is to be used. Irrespective of the configuration of the arrangement, the result is a reliable arrangement and very good damping of the piston movement.

In an embodiment of the arrangement, the valve device is a solenoid valve which makes it possible to control with satisfactory precision the compressed air flow to and from the compressed air cylinder's spaces.

The arrangement according to the invention may with advantage be used in a gearbox in which the compressed air cylinder's longitudinal spindle is connected to any of the shafts of the gearbox which are used in connecting/disconnecting the various gear positions in the gearbox. The arrangement according to the invention reduces the wear on the constituent parts of the gearbox and the amount of noise generated each time the piston hits the compressed air cylinder's casing.

When the arrangement is used in a gearbox, the compressed air cylinder's longitudinal spindle may with advantage be connected to a lateral thrust shaft in the gearbox. The lateral thrust shaft is transversal relative to the main shaft and the countershaft of the gearbox.

The present invention relates also to a method for damping of a piston movement in an arrangement as above, which method comprises the steps of:
the control unit activating the valve device so that the space to be used for damping of the piston's movement is pressurised at least once before the piston's movement begins, in order thereby to damp the piston's movement before it reaches the casing;
the control unit activating the valve device to pressurise the space which generates the piston movement in the desired direction.

This method provides very good damping of the piston movement without requiring major modifications of existing compressed air cylinders.

An embodiment of the method comprises also the step of detecting the piston's position and of the control unit using that information for reliable control of the pressurisation of the spaces in the compressed air cylinder. This further step makes it possible to achieve more precise control of the piston damping on the basis of prevailing conditions.

In an embodiment of the method, the two spaces are pressurised simultaneously, which is a simple and therefore reliable way of utilising the desired damping, resulting in less complicated control units and control means.

An embodiment of the method comprises also the step of the air in the space used for damping the piston's movement being allowed, some time after the space has been pressurised, to leave the space via the compressed air hose or pipe by the control unit opening the compressed air valve. This further step represents a further parameter for optimising the piston damping.

### BRIEF DESCRIPTION OF THE DRAWINGS

The invention is explained in more detail below with reference to its embodiments depicted in the drawings, in which:

FIG. 1 depicts schematically a first embodiment of a compressed air cylinder.

FIG. 2 depicts schematically a second embodiment of a compressed air cylinder.

FIG. 3 is a schematic diagram of an alternative for pressurisation of the compressed air cylinder's spaces.

FIG. 4 is a schematic diagram of a second alternative for pressurisation of the compressed air cylinder's spaces.

### DETAILED DESCRIPTION OF THE INVENTION

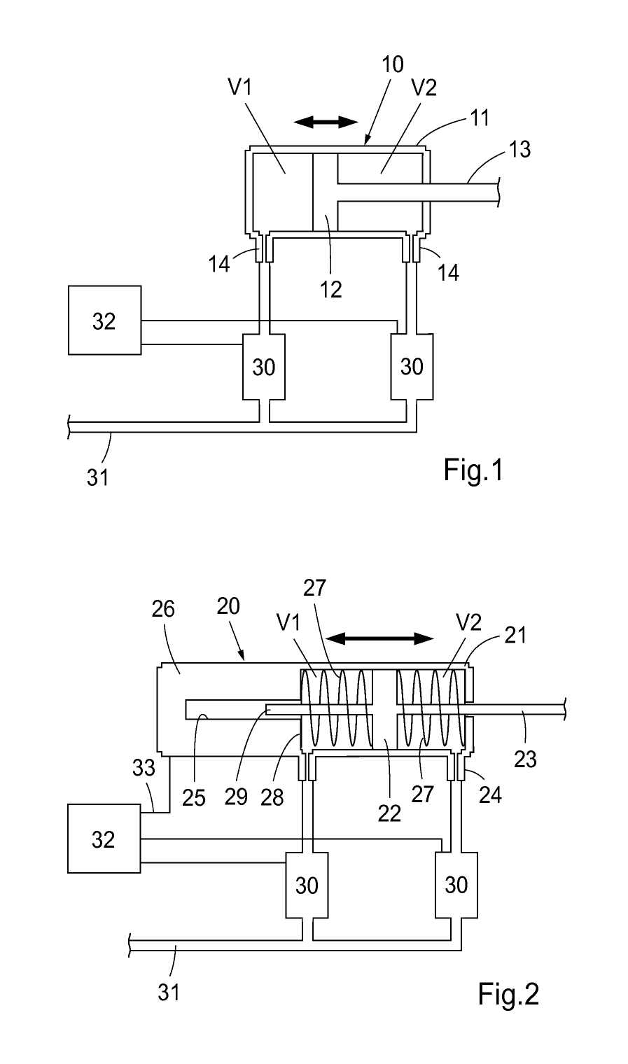

FIG. 1 depicts schematically a first embodiment of a very simple compressed air cylinder 10. The compressed air cylinder comprises a casing 11 which houses a piston 12 and a longitudinal spindle 13 which is connected thereto and which extends from the centre of one side of the piston, through one end wall of the compressed air cylinder 10 and out from the casing 11 so that the axial movement generated by the compressed air cylinder can be put to appropriate use in desired applications.

The internal cavity of the compressed air cylinder 10 is substantially circular cylindrical but other shapes are also possible provided that they conform to the shape of the piston. For the compressed air cylinder to function as intended it is important for there to be good seals between the outer periphery of the piston and the inside of the cavity, and between the periphery of the spindle and the outlet in the casing end wall. There are various types of sliding seals which may be placed on the outer periphery of the piston and on the inner surface of the outlet. The configuration of the outside of the casing may vary depending on the application in which the compressed air cylinder is to be used.

A space whose magnitude (volume) depends on the piston's position in the compressed air cylinder is formed in the cavity on each side of the piston 12. In FIGS. 1 and 2, one space is designated V1 and the space on the opposite side of the piston is designated V2. As previously mentioned, the volume of these spaces depends on the piston's axial position in the cavity. In the embodiment depicted in FIG. 1, the piston and the spindle connected to it are movable between two different positions at the respective ends of the cavity, whereas the piston in the embodiment of the compressed air cylinder depicted in FIG. 2 is movable between three different positions.

At each end of the compressed air cylinder, a compressed air hose 14 with associated compressed air valve 30 is connected to the cavity near to the respective end wall in such a way that one hose leads into the space V1 and the other hose leads into the space V2 on the opposite side of the piston. The respective compressed air hoses 14 are connected to a compressed air source 31 which constantly supplies them with compressed air. The piston and hence the spindle connected to it can be moved in desired directions between the two positions by opening the valve and thereby connecting the compressed air and pressurising the respective spaces V1 and V2.

FIG. 2 depicts a second embodiment of a compressed air cylinder 20. This compressed air cylinder likewise has a surrounding casing 21 which contains a substantially circular cylindrical cavity and a piston 22 and a longitudinal spindle 23 connected thereto. In this case the spindle 23 extends out from both sides of the centre of the piston. On one side of the piston it extends from the piston, through the space V2 on that side of the piston and out from the casing 21 so that the axial movement generated by the compressed air cylinder can be put to appropriate use.

On the other side of the piston 22, a second spindle 29 extends coaxially with the first spindle 23. The second spindle 29 serves as part of a position determination unit 26 situated in the axial extension of the space. The position determination unit 26 comprises also a recess 25 situated at the centre of the end wall 28 of the space. When the piston 22 moves towards or away from the end wall 28, the second spindle 29 moves in the recess 25 which is at least as long as the length of the second spindle 29. The position determination unit 26 detects the position of the spindle in the recess 25 and makes it possible to detect the piston's speed of movement in the compressed air cylinder. The position determination unit is of course also usable in combination with the first embodiment of the compressed air cylinder.

The compressed air cylinder comprises also two coil springs 27 each situated in an axial direction between the end wall of the respective space and the respective side of the piston. The main function of these coil springs is to return the piston and the associated spindles to the piston's position of rest at substantially the centre of the compressed air cylinder in cases where the piston is movable in two axial directions in the compressed air cylinder from the position of rest. As in the compressed air cylinder embodiment described above, this compressed air cylinder is provided with compressed air hoses 24 and compressed air valves, not depicted, situated at the respective ends of the cavity.

The compressed air valves, whatever their configuration, are controlled by a control unit 32 which comprises control means such as programme codes for effecting desired control of the compressed air valves on the basis of certain parameters. If the compressed air cylinder is provided with position determination devices for detecting the piston's position and speed, this is a parameter used inter alia by the control unit.

When the axial movement generated by the compressed air cylinders as described above is needed, a control unit activates the compressed air valve which, upon pressurisation and supply of compressed air to the selected space, generates the desired piston and spindle movement. With the object however of achieving damping of the piston movement, the control unit, either before or at the same time as it activates the space to achieve the piston movement, activates the compressed air valve which pressurises the second space in the compressed air cylinder so that the compressed air in that space serves as damping medium and damps the piston movement. The compressed air in that space will thereby effectively damp the piston movement before the piston reaches the end of the cavity.

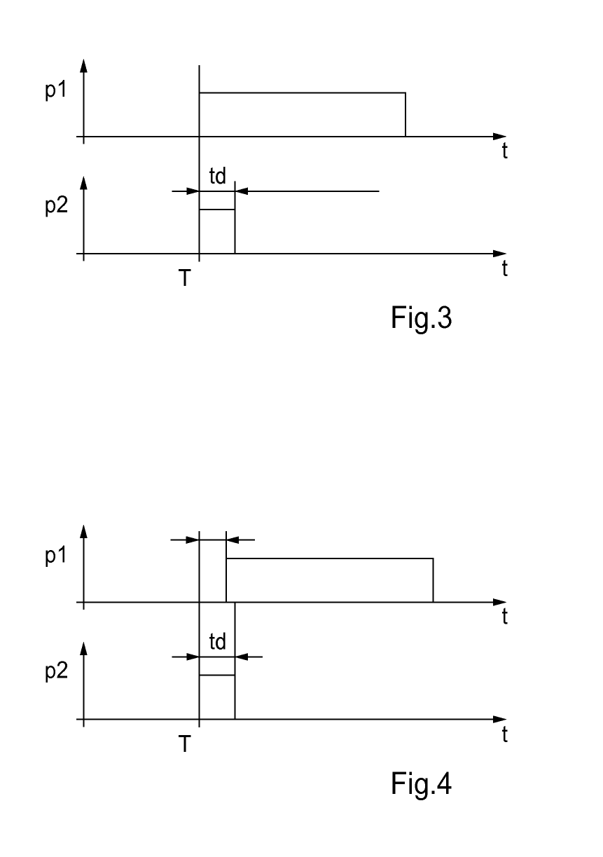

The pressurisation of the space used for damping of the piston movement may take place at any time ranging from shortly before the pressurisation of the space for generating the piston movement to simultaneously with the pressurisation of the space which generates the piston movement. However, to achieve the desired damping of the piston, the pressurisation of the space to damp the piston movement has always to be activated before the piston's movement in the compressed air cylinder begins. Examples of this are depicted schematically in FIGS. 3 and 4, in which the pressurisation p1 denoting the pressurisation of the space for generating the piston movement, and p2 which constitutes the piston damping are illustrated as a function of time. In FIG. 3, the space V1 for the piston movement and the damping space V2 are pressurised simultaneously at a time T, but the pressure p2 in space V2 is removed after a time t_{d}.

In FIG. 4, however, p2, i.e. the damping space V2, is pressurised at time T which is shortly before the pressurisation p1, i.e. the pressurisation for achieving the piston movement. In certain applications this method is very appropriate in making greater damping possible where this is desirable. In both cases the length of the pressurisation time t_{d} may be used as a parameter for further controlling the amount of piston damping applied. This may for example be used to adjust the damping according to, for example, the temperature in the gearbox where the compressed air valve is used, since the viscosity of the lubricant depends on the temperature. Longer activation times t_{d} result in greater piston damping.

The compressed air is thus used partly to generate the desired piston movement, but also as damping medium by means of the control unit which, on selected occasions, activates the pressurisation of the opposite space in order to damp the piston's movement.

The pressurisation of the space which is to damp the piston movement is ended by the control unit opening the compressed air valve, whereupon the force of the piston causes the air in the space to flow out from the space via the compressed air hose and out into the surrounding air.

The invention is described above in the form of various embodiments, but a number of modifications are conceivable, such as:
The compressed air cylinder may be configured in various different ways, e.g. as regards its cross-sectional shape.
The compressed air cylinder might have more positions in which the piston can rest.
The control unit may be configured and adapted to suit desired damping characteristics.

Although it has been described on the basis of some exemplifying embodiments, the invention is not limited to them but is defined on the basis of the accompanying claims.

1. An arrangement for damping of a piston movement in a compressed air cylinder wherein the arrangement comprises:
a compressed air cylinder, with at least one longitudinal spindle for transmission of force from the compressed air cylinder, the compressed air cylinder comprises a casing;
a piston movable longitudinally in the cylinder and joined to the longitudinal spindle for moving the piston longitudinally in the cylinder, the piston is shaped and placed in the cylinder such that a respective space is formed in the cylinder on each side of the piston, a compressed air hose or pipe connected to each space;
a valve device arranged along each compressed air hose or pipe;
a compressed air device for supplying compressed air to each space via respective ones of the compressed air hoses or pipes, and
a control unit connected to each valve device, the control unit is configured and operable to control each valve device when compressed air is supplied to or allowed to leave each space in the compressed air cylinder via the compressed air hoses or pipes, the control unit is configured and operable for controlling the valve devices to control the supply of compressed air to the respective spaces in the compressed air cylinder to supply compressed air to a first one of the spaces to generate a movement of the piston and the spindle thereto connected, and the valve devices are controlled so that compressed air is supplied to the second one of the spaces before movement of the piston has begun, in order thereby to damp the movement of the piston caused by the air supplied to the first space.

2. An arrangement according to claim 1, further comprising a detector for detecting the position of the piston and transmitting the detected position as a parameter to the control unit in order to determine when to supply compressed air to the spaces.

3. An arrangement according to claim 2, further comprising the detector for the position of the piston is in an axial extension of the spaces, the detector comprises a second spindle which is situated on an opposite side of the piston from the spindle; and
a position determination unit comprising a recess in which the second spindle moves configured and operable for detecting the position of the piston in the compressed air cylinder.

4. An arrangement according to claim 1, wherein the piston is movable between two positions in the compressed air cylinder.

5. An arrangement according to claim 1, wherein the piston is movable between three positions in the compressed air cylinder including two spaced apart positions and a middle position of rest between the two spaced apart positions and a respective coil spring at the spindle between the piston and the casing located on each side of the piston urging the piston to the position of rest.

6. An arrangement according claim 1, wherein the valve device is a solenoid valve.

7. A gearbox comprising an arrangement according to claim 1, wherein the gearbox includes a plurality of shafts and the longitudinal spindle of the compressed air cylinder is connected to any of the shafts of the gearbox as the shafts are used when connecting/disconnecting various gear positions in the gearbox.

8. A gearbox according to claim 7, wherein the longitudinal spindle is connected to a lateral thrust shaft in the gearbox.

9. A method for damping piston movement in an arrangement according to claim 1, the method comprising the steps of:
the control unit activating the valve device for pressurising one of the spaces selected to be used for damping of the movement of the piston at least once before movement of the piston begins, for damping the movement of the piston as caused by pressurising the other of the spaces before the piston reaches the casing as it moves through the spaces and;
the control unit activating the valve device to pressurise the other one of the spaces for generating the piston movement in the selected direction.

10. A method according to claim 9, further comprising detecting the position of the piston in the compressed air cylinder such that the control unit uses that information for reliable control of the pressurisation of the spaces.

11. A method according to claim 9 wherein the control unit pressurises the spaces simultaneously.

12. A method according to any one of claims 9, further comprising the step of returning the piston to a position of rest.

13. A method according to claim 9, further comprising allowing air in the space for damping the movement of the piston a time after the space has been pressurized, and allowing air to leave the space via the compressed air hose or pipe and as the control unit opens the valve device.

14. An arrangement according to claim 3, wherein the second spindle is co-axial with the spindle.
